(19) United States
(12) Patent Application Publication
(10) Pub. No.: US 2019/0296458 A1
(43) Pub. Date: Sep. 26, 2019

(54) GROUNDING ELASTIC COMPONENT

(71) Applicant: SHENZHEN JOHAN MATERIAL TECH. CO., LTD., Shenzhen (CN)

(72) Inventor: JINGYUN LIU, Shenzhen (CN)

(21) Appl. No.: 16/167,548

(22) Filed: Oct. 23, 2018

Related U.S. Application Data
(63) Continuation of application No. PCT/CN2018/080061, filed on Mar. 22, 2018.

(51) Int. Cl. H01R 4/64; H01R 4/48; C09J 7/20; C09J 9/02; H01B 1/22; B32B 15/08; B32B 7/12

(52) U.S. Cl. CPC H01R 4/64; H01R 4/48; C09J 7/20; B32B 7/12; H01B 1/22; B32B 15/08; C09J 9/02

(57) ABSTRACT

The invention discloses a grounding elastic component, including a elastic body and a conductive thin film. A convex block is provided on a lower surface of the elastic body, which convex block divides the lower surface of the elastic body into a first region and a second region. A conductive metal layer is provided on one side of the conductive thin film, and the other side of the conductive thin film, which is opposite to the one side the conductive metal layer is provided on, is wrapped on an upper surface, the first region of the lower surface and a side wall of the elastic body. The conductive thin film is bonded with the upper surface and the first region of the lower surface of the elastic body by a non-conductive double-sided adhesive. A double-sided adhesive tape is provided on the second region of the lower surface of the elastic body. The present invention can achieve that the resistance value does not change with the changing of compression amount, the resistance value is more stable, the bounciness force is stable and the production cost is low.

### BACKGROUND OF INVENTION

### 1. Field of Invention

The present disclosure relates to an elastomer, and particularly relates to a grounding elastic component.

### 2. Description of Prior Art

At present, as a grounding component on the back cover of a mobile phone, an omni-directional conductive foam is generally used to realize the grounding function, which omni-directional conductive foam is bonded on the back cover of the mobile phone by a conductive resin. However, the resistance value of the omni-directional conductive foam is easy to change under different compression amounts, which will affect the grounding performance. Meanwhile, the bounciness force of the omni-directional conductive foam is also very unstable, so it is quite difficult to guarantee a reliable contact. It is not applicable to the situation where the resistance value is required to be more stable and where it is sensitive to pressure.

### SUMMARY OF INVENTION

The technical problem to be solved by the present disclose is as follows:

To provide a ground elastic component which can achieve that the resistance value does not change with the changing of compression amount, the resistance value is more stable, the bounciness force is stable and the production cost is low.

In order to solve the above problem, the present disclosure is to provide a grounding elastic component, including an elastic body and a conductive thin film. A convex block is provided on a lower surface of the elastic body, which convex block divides the lower surface of the elastic body into a first region and a second region. A conductive metal layer is provided on one side of the conductive thin film, and the other side of the conductive thin film, which is opposite to the one side the conductive metal layer is provided on, is wrapped on an upper surface, the first region of the lower surface and a side wall of the elastic body. The conductive thin film is bonded with the upper surface and the first region of the lower surface of the elastic body by a non-conductive double-sided adhesive. A double-sided adhesive tape is provided on the second region of the lower surface of the elastic body.

Furthermore, the elastic body is a silicone foam.

Furthermore, the thickness of the conductive thin film is less than 0.02 mm.

The above technical solution at least has the following benefits: in present invention, the other side of the conductive thin film, which is opposite to the one side the conductive metal layer is provided on, is wrapped on an upper surface, the first region of the lower surface and a side wall of the elastic body, the conductive thin film is bonded with the upper surface and the first region of the lower surface of the elastic body by a non-conductive double-sided adhesive; and a double-sided adhesive tape is provided on the second region of the lower surface of the elastic body, thus the resistance value does not change with the changing of compression amount, the resistance value is more stable, the bounciness force is stable and the production cost is low.

### BRIEF DESCRIPTION OF DRAWINGS

FIG. 1 is a first sectional structural view of a grounding elastic component according to the present invention.

FIG. 2 is a second sectional structural view of the grounding elastic component to the present invention.

### DETAILED DESCRIPTION OF PREFERRED EMBODIMENTS

It should be understood that in the case that no conflict occurs, the embodiments and the technical features thereof in this application can be combined with each other. The present disclose is further described in detail in accordance with the figures.

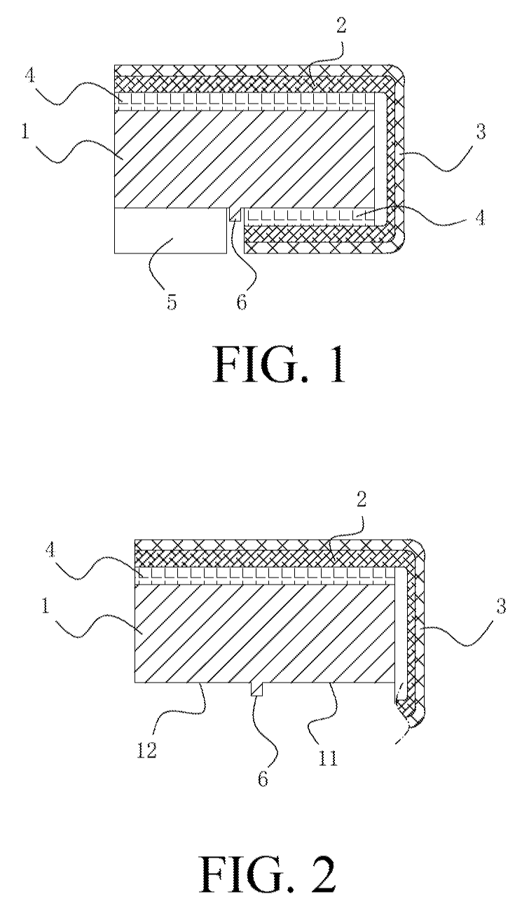

As shown in FIG. 1 and FIG. 2, a grounding elastic component according to an embodiment of the present invention comprises an elastic body 1 and a conductive thin film 2. A convex block 6 is provided on a lower surface of the elastic body 1, which convex block 6 divides the lower surface of the elastic body into a first region 11 and a second region 12. A conductive metal layer 3 is provided on one side of the conductive thin film 2, and the other side of the conductive thin film 2, which is opposite to the one side the conductive metal layer 3 is provided on, is wrapped on an upper surface, the first region 11 of the lower surface and a side wall of the elastic body 1. The conductive thin film 2 is bonded with the upper surface and the first region 11 of the lower surface of the elastic body 1 by a non-conductive double-sided adhesive 4. A double-sided adhesive tape 5 is provided on the second region 12 of the lower surface of the elastic body 1. When used, the elastic body 1 is bonded on the back cover of a mobile phone by the double-sided tape 5, so that the grounding elastic component is fixed. Since the conductive thin film 2 is only wrapped on a part of the lower surface of the elastic body 1, without completely covering the lower surface of the elastic body 1, it can reduce materials of the conductive thin film 2 and lower the production cost. In the process of bonding the elastic body 1 onto the hack cover of the mobile phone with the double-sided tape 5, the convex block 6 plays the role in separating and positioning so as to conveniently paste the double-sided tape 5.

The conductive function of the grounding elastic component mainly depends on the conductive metal layer 3 of the conductive film 2 itself, and does not rely on any conductive adhesive or conductive foam, namely, the conductive metal layer 3 itself contacts with a grounding matter. The conductive metal layer 3 has a stable overall structure, the resistance value of which is also very stable. Since the conductive metal layer 3 is very thin and of a good deformation character, even if the elastic body 1 is stressed and compressed, it will not affect the structure of the conductive metal layer 3. The current goes directly from upper to lower without going through other conductors any longer, the resistance is small and very stable, and it is not affected by forms.

The whole resistance value of this structure only depends on the conductive metal layer 3 itself and thus can be controlled singly. The resistance value is very low, stable and of an advantage of high resistance consistency, which is especially applicable for some devices with strict requirement for resistance value, such as grounding of radio frequency antenna, which requires low resistance and stable grounding performance.

The conductive thin film 2 is wrapped on the upper surface, the first region 11 of the lower surface and the side wall of the elastic body 1, and the thickness of the conductive thin film 2 is less than 0.02 mm. Since this open-type wrapped structure is used, the stable elastic body 1 which reacts stably to bounce force can be chosen as a filler in the middle, such as silicone foam, by this way, a stable bounce force can be achieved. The stress of the open-type wrapped structure in a compression state is very small, and one side of the elastic body 1 is not restricted, thus the volume can become smaller, which saves space. The elastic body 1 with good elasticity can, even on a narrow contacting point, guarantee a good contact. By choosing an appropriate elastic body 1, it can guarantee the bounce force stays consistent and works normally in various high temperature situations.

The above is a specific implementation of the present invention; and it should be pointed out that a normal person skilled in the art can still, without beyond the principle of the present invention, make improvements and retouching which shall be considered as the protection scope of the present invention as well.

1. A grounding elastic component, comprising an elastic body and a conductive thin film; wherein
a convex block is provided on a lower surface of the elastic body, which the convex block divides the lower surface of the elastic body into a first region and a second region;
a conductive metal layer is provided on one side of the conductive thin film, and the other side of the conductive thin film, which is opposite to another side the conductive metal layer is provided on, is wrapped on an upper surface, the first region of the lower surface and a side wall of the elastic body;
the conductive thin film is bonded with the upper surface and the first region of the lower surface of the elastic body by a non-conductive double-sided adhesive; and
a double-sided adhesive tape is provided on the second region of the lower surface of the elastic body.

2. The grounding elastic component as claimed in claim 1, wherein the elastic body is a silicone foam.

3. The grounding elastic component as claimed in claim 1, wherein the thickness of the conductive thin film is less than 0.02 mm.
